(19) United States
(12) Patent Application Publication
(10) Pub. No.: US 2012/0055175 A1
(43) Pub. Date: Mar. 8, 2012

(54) Automobile Hybrid Air Conditioning System

(75) Inventors: Wai Lam Ting, Kowloon (HK); Ka-Wai Eric Cheng, Hung Hom (HK); Yiu Pun Benny Yeung, Hung Hom (HK); Wing Wa Chan, Hung Hom (HK); Chun Yuen Lam, Hung Hom (HK); Wai Fung Choi, Hung Hom (HK); Tsz Wang Ng., Hung Hom (HK); Chup Chung Wong, Kowloon Tong (HK); Meng Chen, Kowloon Tong (HK); Man Chit Chan, Kowloon Tong (HK)

(73) Assignee: Automotive Parts and Accessory Systems R&D Centre Ltd, Kowloon Tong (HK)

(21) Appl. No.: 12/875,860

(22) Filed: Sep. 3, 2010

(51) Int. Cl. B60H 1/32; F25B 27/00

(52) U.S. Cl. 62/61; 62/323.4; 62/241; 62/133

(57) ABSTRACT

A hybrid air conditioning system for a combustion engine vehicle. When the combustion engine is running and a rechargeable battery unit is not at full charge, an electric machine is configured by an MCU control unit as mechanically coupled to the combustion engine, and a battery charger is configured as electrically connected to the rechargeable battery unit such that the electric machine generates electric power to recharge the rechargeable battery unit. When the combustion engine stops and air conditioning is required, the rechargeable battery unit is configured by the MCU control unit as electrically connected to a motor drive, and the electric machine is configured as mechanically coupled to the compressor to provide mechanical power to drive the compressor. This allows the automobile air conditioning system to operate for a limited period of time after the combustion engine stops.

### BACKGROUND OF THE INVENTION

1. Field of the Invention

The invention is related to air conditioning systems for vehicles, and particularly related to air conditioning systems for vehicles powered by internal combustion engine.

2. Description of Related Art

An air conditioning system provides a human comfort environment by controlling a suitable range of air temperature and humidity in the living environment. The history of air conditioning systems is over one century old. In 1939, an air conditioning system for an automobile was developed by Packard Motor Car Company. By 1969 more than 50% of the automobiles sold in the United States were equipped with automobile air conditioning systems. Nowadays, automobile air conditioning systems have become one of the necessary items of equipments in automobiles.

In the conventional art, the long standing dilemma of vehicle air-conditioning faced by vehicles powered solely by internal combustion engines is that, when they are stopped for a short period, keeping the air-conditioning running requires continuous operation of the engine and hence increases fuel consumption and exhaust gas emission. Switching off the engine and hence the air-conditioning results in a temperature rise. In tropical and subtropical geographical areas such as South China, cabin temperatures can rise rapidly beyond a bearable level shortly after the air-conditioning is switched off. The advent of the hybrid electric vehicle provides an ideal platform to address this problem. Examples of such systems are disclosed in U.S. Pat. Nos. 6,840,055 and 6,516,621. However, these systems are not suitable for conventional internal engine powered vehicles.

FIG. 1 shows the basic structure of a conventional automobile air conditioning (A/C) system. In this system the A/C compressor 3 is driven by the engine 1 of the vehicle. The clutch 2 is an electromagnetic clutch which is integrated in most A/C compressors. A/C temperature control relies on switching the clutch off and on. This structure is simple and easy for maintenance. However, the speed of the engine changes frequently in a wide range of speeds when the vehicle is running on the road. The speed of the compressor changes independently of the A/C temperature and hence the A/C temperature fluctuates. Another disadvantage of the conventional air conditioning system is that the air conditioning system has to be shut down when the engine is shut down (vehicle off).

Accordingly, a need exists for an improved automobile air conditioning system to provide air-conditioning when the operation of the combustion engine is off, and to drive the speed of the compressor in such a manner as to provide a steady A/C temperature.

### SUMMARY

Several aspects of the presently claimed invention have been developed with a view to substantially reduce or eliminate the drawbacks described hereinbefore and known to those skilled in the art and to provide an automobile hybrid air conditioning system that may be adopted to offer air-conditioning without the need to keep the vehicle combustion engine running, thus reducing fuel consumption and exhaust gas emission. Some embodiments of the invention provide steady temperature irrespective of speed changes in the combustion engine. The compressor of this system is driven by the internal combustion engine when the engine is running as a conventional automobile air conditioning system. When the engine is shut down, the A/C compressor of this system is driven by an electric machine, in some embodiments a brushless DC (BLDC) machine, powered by a rechargeable battery unit, in some embodiments a 24-volt lead acid battery. When the battery voltage level is low, resulting from partial discharge, the battery is recharged with electric power generated from the same electric machine driven by the engine. The A/C temperature may be controlled by varying the speed of the electric machine.

According to an aspect of the presently claimed invention, there is provided a hybrid air conditioning system for a combustion engine vehicle. The system includes a combustion engine mechanically coupled to the transmission system of the vehicle; a rechargeable battery unit selectively connected to a battery charger and a motor drive electrically; and an electric machine electrically connected to the battery charger and the motor drive. The electric machine is further selectively coupled to the combustion engine mechanically. A compressor for air conditioning is selectively coupled to the combustion engine and the electric machine mechanically. When the combustion engine is running and the rechargeable battery unit is low, the electric machine is configured by an MCU control unit as mechanically coupled to the combustion engine, and the battery charger is configured as electrically connected to the rechargeable battery unit such that the electric machine generates electric power to recharge the rechargeable battery unit. When the combustion engine stops and air conditioning is required, the rechargeable battery unit is configured by the MCU control unit as electrically connected to the motor drive, and the electric machine is configured as mechanically coupled to the compressor to provide mechanical power to drive the compressor.

In some embodiments the hybrid air conditioning system further includes a first clutch, a second clutch and a third clutch. The clutches are mechanically coupled with each other by pulleys and belt. The first clutch is mechanically coupled to the combustion engine, for example by pulleys and belt; the second clutch is mechanically coupled to the compressor; and the third clutch is mechanically coupled to the DC electric machine.

In some embodiments the hybrid air conditioning system further includes a first relay and a second relay. The first relay electrically connects the output of the battery charger to the rechargeable battery unit and the second relay electrically connects the motor drive to the rechargeable battery unit. In some embodiments the first relay and the second relay have normally-open switch contacts which provide electrical connection when the relay is energized.

In some embodiment, when the combustion engine is running and air conditioning is required, the compressor is configured as mechanically coupled to the combustion engine such that the combustion engine produces mechanical power for driving the compressor.

In some embodiments, the hybrid air conditioning system further includes a battery charger controller, for example in the MCU control unit, for monitoring both the rechargeable battery voltage and the speed of the electric machine. When the electric machine is generating electric power for charging the rechargeable battery unit, the charging current applied to the rechargeable battery unit is controlled by the battery charger controller to be directly proportional to the speed of the electric machine.

According to another aspect of the presently claimed invention, there is provided a hybrid air conditioning controller for a combustion engine vehicle. The combustion engine vehicle has a combustion engine, a rechargeable battery unit, a battery charger, a electric machine, and a compressor for air conditioning. When the combustion engine is running and the rechargeable battery unit is partly discharged, the hybrid air conditioning controller configures the electric machine as mechanically coupled to the combustion engine, and the hybrid air conditioning controller configures the battery charger as electrically connected to the rechargeable battery unit such that the electric machine generates electric power to recharge the rechargeable battery unit. When the combustion engine stops and air conditioning is required, the hybrid air conditioning controller configures the rechargeable battery unit as electrically connected to the motor drive and the electric machine as mechanically coupled to the compressor to provide mechanical power to drive the compressor.

In some embodiments, when the combustion engine is running and air conditioning is required, the hybrid air conditioning controller configures the compressor as mechanically coupled to the combustion engine such that the combustion engine produces mechanical power for driving the compressor.

In another embodiment, the hybrid air conditioning controller further includes a battery charger controller for monitoring both the rechargeable battery voltage and the speed of the electric machine. When the electric machine is generating electric power for charging the rechargeable battery unit, the charging current applied to the rechargeable battery unit is controlled by the battery charger controller to be directly proportional to the speed of the electric machine.

According to a further aspect of the presently claimed invention, there is provided a method of hybrid air conditioning for combustion engine vehicle, the combustion engine vehicle having a combustion engine, a rechargeable battery unit, a battery charger, a electric machine, and a compressor for air conditioning. The method includes, when the combustion engine is running and the rechargeable battery unit is low, configuring the electric machine as mechanically coupled to the combustion engine and the battery charger as electrically connected to the rechargeable battery unit such that the electric machine generates electric power to recharge the rechargeable battery unit. When the combustion engine stops and air conditioning is required, the method includes configuring the rechargeable battery unit as electrically connected to the motor drive, and the electric machine is configured as mechanically coupled to the compressor to provide mechanical power to drive the compressor.

In some embodiments the method further includes, when the combustion engine is running and air conditioning is required, configuring the compressor as mechanically coupled to the combustion engine such that the combustion engine produces mechanical power for driving the compressor.

In some embodiments the method also includes monitoring both the rechargeable battery voltage and the speed of the electric machine. When the electric machine is generating electric power for charging the rechargeable battery unit, the charging current applied to the rechargeable battery unit is controlled to be directly proportional to the speed of the electric machine.

### BRIEF DESCRIPTION OF THE DRAWINGS

FIG. 1 is a system diagram of a conventional automobile air conditioning system according to the prior art.

FIG. 2 is a system diagram in accordance with an embodiment of the present invention.

FIG. 3 is an equivalent system diagram in accordance with an embodiment of the present invention in mode 1 operation.

FIG. 4 is an equivalent system diagram in accordance with an embodiment of the present invention in mode 2 operation.

FIG. 5 is an equivalent system diagram in accordance with an embodiment of the present invention in mode 3 operation.

FIG. 6 is an equivalent system diagram in accordance with an embodiment of the present invention in mode 4 operation.

FIG. 7 is an equivalent system diagram in accordance with an embodiment of the present invention in mode 5 operation.

FIG. 8 is a bi-directional drive in accordance with a further embodiment of the present invention.

FIG. 9 is a state diagram of the control flow in accordance with an embodiment of the present invention.

### DESCRIPTION OF EMBODIMENTS

An automobile hybrid air conditioning system is described hereinafter. In the following description, numerous specific details, including electrical components, mechanical components, and the like are set forth. However, from this disclosure, it will be apparent to those skilled in the art that modifications and substitutions may be made without departing from the scope of the invention. In other circumstances, specific details may be omitted so as not to obscure the invention.

Where reference is made in any one or more of the accompanying drawings to steps and features which have the same reference numerals, those steps and features have for the purposes of this description the same function(s) or operation(s), unless the contrary intention appears.

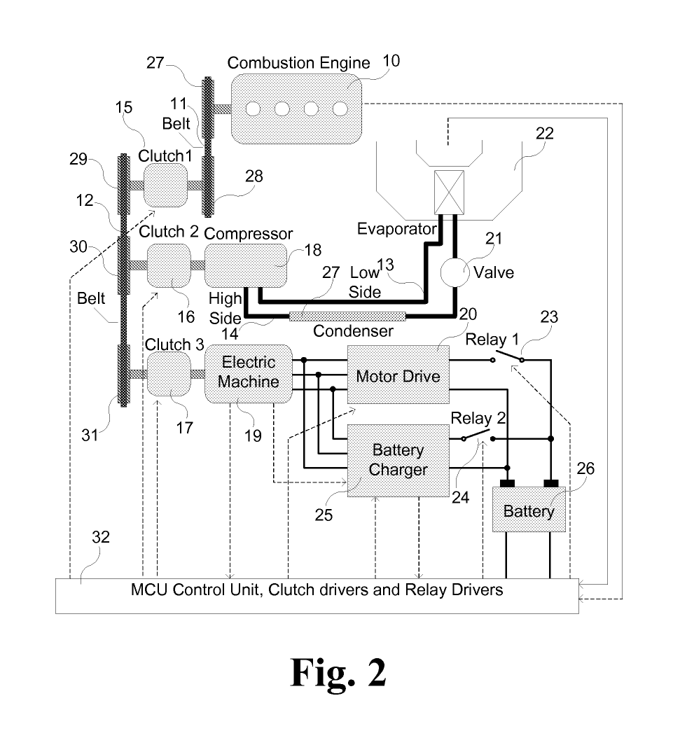

The embodiments of the present invention provide automobile air conditioning systems that are capable of operating for a limited time period when the combustion engine vehicle stops. FIG. 2 shows an automobile air conditioning system diagram in accordance with an embodiment of the present invention. The system comprises an A/C compressor 18 integrated with an electromagnetic clutch 16, two further electromagnetic clutches 16, 17, a valve 21, a condenser 27, an evaporator 22, belts 11, 12 and belt pulleys 27, 28, 29, 30, 31, a brushless DC electric machine 19, a motor drive 20, a rechargeable battery 26, a battery charger 25, tubes in high pressure 14, tubes in low pressure 13, two relays 23, 24, and an MCU control unit 32.

According to FIG. 2, the clutches 15, 16, 17 are used for switching the mechanical power sources to the A/C compressor 18 between the combustion engine 10 and the electric machine 19. Mechanical power is transmitted by the belt pulleys 27, 28, 29, 30, 31 and the belts 11, 12.

The rechargeable battery 26 is a deep cycle battery so that it is suitable for providing high current in long duration with long life cycles. It powers the motor drive 23, the controller of the battery charger 24 and the MCU control unit 32.

According to an embodiment of the present invention, the electric machine 19 is a brushless DC (BLDC) machine. This type of machine has fast response, high power density, robustness and high reliability. The electric machine 19 can serve as an electric motor as well as an electric generator. It is both for driving the compressor 18 and for generating electric power for charging the rechargeable battery 26. When the BLDC machine 19 drives the A/C compressor 18, it is driven by the motor drive 20. The electric power for driving the BLDC machine is provided by the rechargeable battery 26. The battery charger 25 is responsible for recharging the rechargeable battery 26. The relay 23 is for switching the motor drive 20 on and off. The relay 24 is for connecting and disconnecting the rechargeable battery 26 and the battery charger 25. In an exemplary embodiment of the present invention, the relays 23 and 24 are normally-open type relays. The relay 23 and the relay 24 should not be closed at the same moment.

The MCU control unit 32 is powered by the rechargeable battery 26. It controls on/off states of the relays 23, 24 and closed/open states of the clutches 15, 16, 17. Relay drivers and clutch drivers are built into the MCU control unit 32. It is also responsible for controlling the speed of the electric machine 19 with the motor drive 20 when the machine 19 is in motoring operation. It monitors the speed of the electric machine 19 by a Hall effect position sensor built in the machine 19 and the A/C temperature by a thermal sensor so that the speed of the electric machine 19 and the A/C temperature are under closed-loop control. It also monitors the rechargeable battery 26 voltage and the angular speed of the combustion engine 10. When the speed of the combustion engine 10 is too high while the electric machine 19 is generating power for recharging the rechargeable battery 26, the MCU control unit 32 opens clutch 3 17 in order to avoid damaging the electric machine 19 by over speed and the battery charger 25 by over input voltage.

The controller of the battery charger 25 monitors both the voltage of the rechargeable battery 26 and the speed of the electric machine 19. When the electric machine 19 is generating electric power for recharging the rechargeable battery 26, its output voltage of the electric machine 19 is substantially in direct proportion relationship with its angular speed. The charging current of the rechargeable battery 26 is controlled by the controller of the battery charger 25. It is proportional to the speed of the electric machine 19 and hence, over input current of the battery charger 25 is prevented. The rechargeable battery 26 can be rechargeable even when the combustion engine is at low speed.

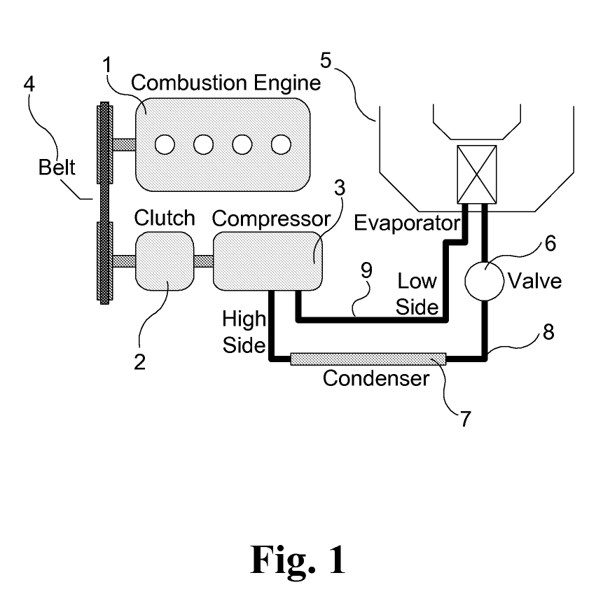

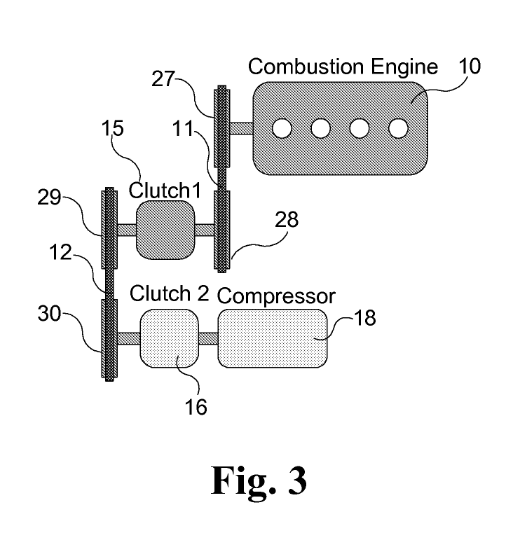

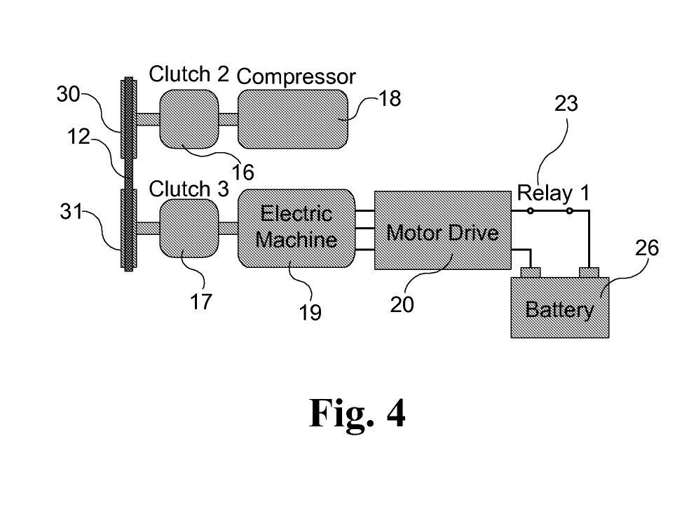

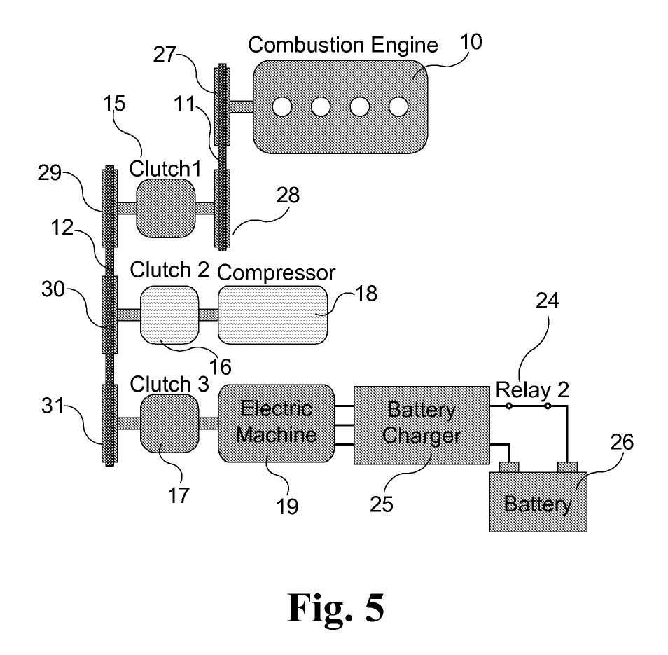

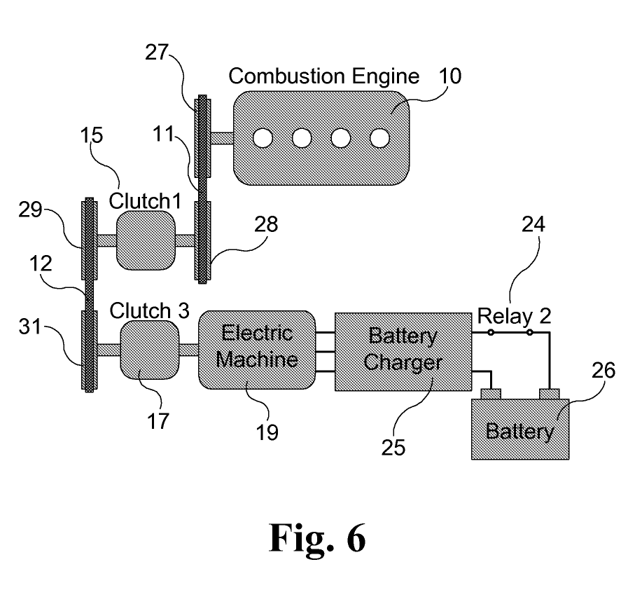

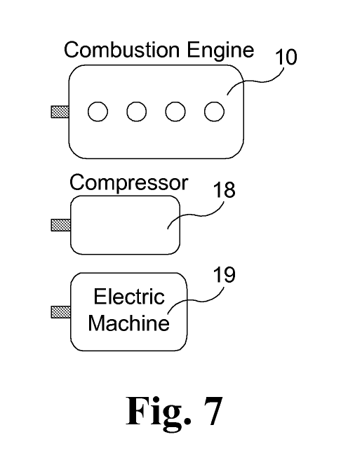

The operation of the automobile hybrid air conditioning system of the present invention shown in FIG. 1 is considered as 5 modes of operation. The equivalent system diagrams of the modes of operation of the present invention are shown in FIG. 3, FIG. 4, FIG. 5, FIG. 6 and FIG. 7. The modes of operation are described in the following:

### Mode 1

FIG. 3 shows an equivalent system diagram in accordance with an embodiment in Mode 1 operation. In this mode of operation, the vehicle is on and the air conditioning system is on. The combustion engine 10 is running in Mode 1. The rechargeable battery 26 is fully charged. Clutch 1 15 is closed. Relay 1 23, Relay 2 24 and Clutch 3 17 are open. The combustion engine 10 drives the A/C compressor 18. The electric machine 19 is not operated. The rechargeable battery 26 is not recharged. The room temperature is controlled by switching on and off Clutch 2 16, i.e., switching on and off of the A/C compressor 18.

### Mode 2

FIG. 4 shows an equivalent system diagram in accordance with an embodiment in Mode 2 operation. The vehicle stops in Mode 2. The air conditioning system of the present invention is on. The combustion engine 10 is not running in this moment. Clutch 1 15 and Relay 2 24 are open. Clutch 2 16, Clutch 3 17 and Relay 1 23 are closed. The rechargeable battery 26 produces electric power to the motor drive 20 to drive the electric machine 19, and the electric machine 19 drives the A/C compressor 18. The room temperature is controlled by controlling the speed of the electric machine 19 by the motor drive 20 and the MCU control unit 32. This obtains stable temperature and saves compressor starting energy. The electric machine 19 stops when the voltage of the rechargeable battery 26 reaches its minimum discharge voltage.

### Mode 3

FIG. 5 shows an equivalent system diagram in accordance with an embodiment in Mode 3 operation. The vehicle is running in Mode 3 so that the combustion engine 10 is running in this moment. The rechargeable battery 26 voltage reaches its minimum battery voltage. The air conditioning system of the present invention is on. The rechargeable battery 26 is recharged by the battery charger 25. Clutch 1 15, Clutch 3 17 and Relay 2 24 are all closed. Relay 1 23 is open. The combustion engine 10 drives both the A/C compressor 18 and the electric machine 19. The electric machine 19 generates electric power to the battery charger 25 to recharge the rechargeable battery 25. The A/C temperature is controlled by switching on and off Clutch 2 16.

### Mode 4

FIG. 6 shows an equivalent system diagram in accordance with an embodiment in Mode 4 operation. The air conditioning system of the present invention is off in Mode 4. The combustion engine 10 is running. The rechargeable battery 26 is recharged because its voltage level is low. Clutch 1 15, Clutch 3 17 and Relay 2 24 are closed. Clutch 2 16 and Relay 1 23 are open. The combustion engine 10 drives only the electric machine to generate electric power to the battery charger 25 and to recharge the rechargeable battery 26.

### Mode 5

FIG. 7 shows an equivalent system diagram in accordance with an embodiment in Mode 5 operation. The air conditioning system of the present invention is off in Mode 5. The combustion engine 10 is either running or stop. The rechargeable battery 26 is fully charged. The electric machine 19 neither drives the A/C compressor 18 nor generates electric power. Clutch 1 15, Clutch 2 16, Clutch 3 17, Relay 1 23 and Relay 2 24 are all open.

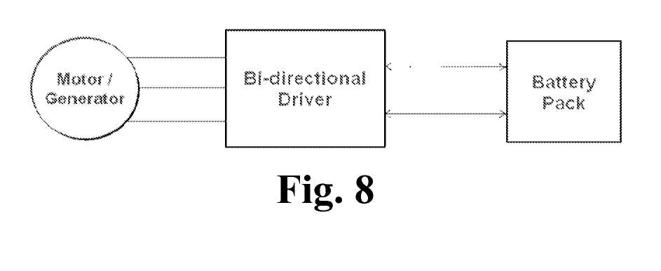

According to another embodiment, the electric drive in FIG. 1 can be replaced by a bi-directional drive as depicted in FIG. 8. The integration of motor drive and battery charger shares certain components of the power electronic circuitry and it eliminates the use of power relays. Thus, it can be made smaller with longer life cycle.

The status of the combustion engine, the air conditioning, and rechargeable battery under different modes are summarized in Table 1 below:

TABLE 1

| Mode | Engine | A/C | Batt |
|---|---|---|---|
| 5 | OFF | OFF | / |
| | RUNS | OFF | FULL |
| 1 | RUNS | ON | FULL |
| 2 | OFF | ON | / |
| 3 | RUNS | ON | LOW |
| 4 | RUNS | OFF | LOW |

FIG. 8 shows a bi-directional drive which replaces the electric drive in FIG. 2 according to a further embodiment of the present invention. The integration of motor drive and battery charger shares certain components of the power electronic circuitry and it eliminates the use of power relays. Thus, it can be made smaller with longer life cycle.

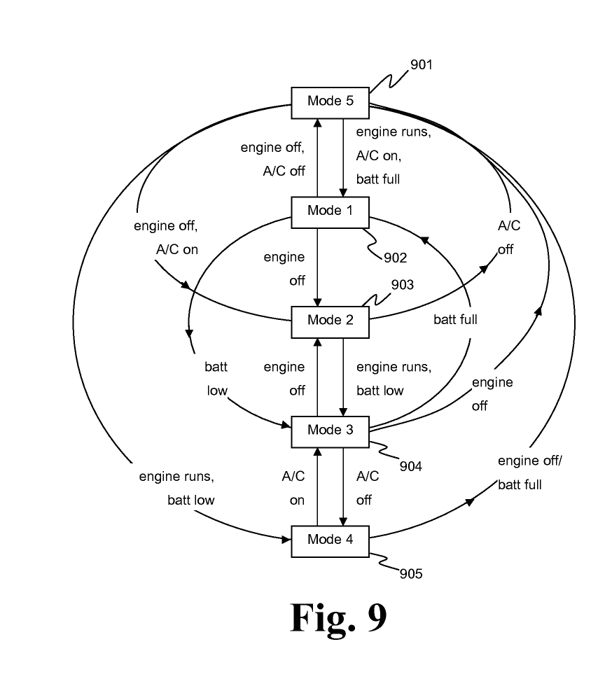

FIG. 9 is a state diagram of the control flow of the automobile hybrid air conditioning system in accordance with an embodiment. The control flow begins at Mode 5, state 901 when the system is started up, both the combustion engine and A/C are turned off in this mode. If the engine is then started to run and the A/C is switched on with full battery level, the state changes to Mode 1, state 902. If the engine is started to run while the battery level is low, the state changes to Mode 4, state 905. If the A/C is turned on while the engine remains off, then the state changes to Mode 2, state 903.

At Mode 1, state 902 where both the engine and A/C are running, if the A/C is then turned off, the state changes to Mode 2, state 903. If the battery level becomes low, the state changes to Mode 3, state 904.

At Mode 2, state 903 where the engine is off and the A/C is running, if the engine is then started to run, the state changes to Mode 3, state 904. If the A/C is turned off, the state changes back to Mode 5, state 901.

At Mode 3, state 904 where both the engine and A/C are running with the battery being charged, if the A/C is then turned off, the state changes to Mode 4, state 905. If the battery level becomes full, the state changes to Mode 1, state 902. If the engine is stopped, the state returns to Mode 5, state 901.

At Mode 4, state 905 where the engine is running, the battery is being charged and the A/C is off, if the A/C is then turned on, the state changes to Mode 3, state 904. If the engine is turned off or the battery level becomes full, the state returns to Mode 5, state 901.

Embodiments described hereinbefore provide air-conditioning when the operation of the vehicle combustion engine is off, and drive the speed of the compressor in such a manner as to provide steady A/C temperature.

The foregoing description provides exemplary embodiments only, and is not intended to limit the scope, applicability or configurations of the present invention. Rather, the description of the exemplary embodiments provides those skilled in the art with enabling descriptions for implementing embodiments of the invention. Various changes may be made in the function and arrangement of elements without departing from the scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

The term “comprising”, as used herein, is intended to have an open-ended, non-exclusive meaning. For example, the term is intended to mean: “including principally, but not necessarily solely” and not to mean “consisting essentially of” or “consisting only of”. Variations of the term “comprising”, such as “comprise”, “comprises” and “is comprised of”, have corresponding meanings.

We claim:

1. A hybrid air conditioning system for a combustion engine vehicle having a combustion engine and a compressor for air conditioning, comprising:
a rechargeable battery unit;
a battery charger electrically connectable to the rechargeable battery unit;
a motor drive electrically connectable to the rechargeable battery unit;
an electric machine electrically connected to the battery charger and the motor drive, the electric machine selectively mechanically connectable to the combustion engine and the compressor for air conditioning; and
an MCU control unit in electrical communication with the rechargeable battery unit, the battery charger, the motor drive, and the electric machine.

2. A hybrid air conditioning system as in claim 1 wherein:
when the combustion engine is running and the rechargeable battery unit is partially discharged, the MCU control unit configures the electric machine as mechanically coupled to the combustion engine, and the MCU control unit configures the battery charger as electrically connected to the rechargeable battery unit such that the electric machine generates electric power to recharge the rechargeable battery unit; and
when the combustion engine stops and air conditioning is required, the MCU control unit configures the rechargeable battery unit as electrically connected to the motor drive, and the MCU control unit configures the electric machine as mechanically coupled to the compressor to provide mechanical power to drive the compressor.

3. A hybrid air conditioning system as in claim 1 and further comprising a first clutch, a second clutch, and a third clutch mechanically coupled to one another, wherein the first clutch is mechanically coupled to the combustion engine, the second clutch is mechanically coupled to the compressor; and the third clutch is mechanically coupled to the electric machine.

4. A hybrid air conditioning system as in claim 1 wherein the first clutch, the second clutch, and the third clutch are mechanically coupled to one another by pulleys and belts.

5. A hybrid air conditioning system as in claim 1 and further comprising a first relay and a second relay, wherein the first relay electrically connects the battery charger to the rechargeable battery unit and the second relay electrically connects the motor drive to the rechargeable battery unit.

6. A hybrid air conditioning system as in claim 1 wherein the first and second relays are normally open.

7. A hybrid air conditioning system as in claim 1 wherein when the combustion engine is running and air conditioning is required, the compressor is configured as mechanically coupled to the combustion engine such that the combustion engine produces mechanical power for driving the compressor.

8. A hybrid air conditioning system as in claim 1 wherein the MCU control unit comprises a battery charger controller that controls charging current to the battery according to the speed of the electric machine.

9. A hybrid air conditioning controller for a combustion engine vehicle, the combustion engine vehicle having a combustion engine, a rechargeable battery unit, a battery charger, an electric machine, and a compressor for air conditioning,
wherein when the combustion engine is running and the rechargeable battery unit is partially discharged, the hybrid air conditioning controller configures the electric machine as mechanically coupled to the combustion engine and the hybrid air conditioning controller configures the battery charger as electrically connected to the rechargeable battery unit such that the electric machine generates electric power to recharge the rechargeable battery unit, and
wherein when the combustion engine stops and air conditioning is required, the hybrid air conditioning controller configures the rechargeable battery unit as electrically connected to the motor drive and the hybrid air conditioning controller configures the electric machine as mechanically coupled to the compressor to provide mechanical power to drive the compressor.

10. A hybrid air conditioning controller as in claim 9 wherein when the combustion engine is running and air conditioning is required, the hybrid air conditioning controller configures the compressor as mechanically coupled to the combustion engine such that the combustion engine produces mechanical power for driving the compressor.

11. A hybrid air conditioning controller as in claim 9 and further comprising a battery charger controller that monitors the rechargeable battery voltage and the speed of the electric machine and that controls the charging current applied to the rechargeable battery unit to be directly proportional to the speed of the electric machine.

12. A method of hybrid air conditioning for a combustion engine vehicle, the combustion engine vehicle having a combustion engine, a rechargeable battery unit, a battery charger, an electric machine, and a compressor for air conditioning comprising:
when the combustion engine is running and the rechargeable battery unit is partially discharged, configuring the electric machine as mechanically coupled to the combustion engine and configuring the battery charger as electrically connected to the rechargeable battery unit such that the electric machine generates electric power to recharge the rechargeable battery unit; and
when the combustion engine stops and air conditioning is required, configuring the rechargeable battery unit as electrically connected to the motor drive and configuring the electric machine as mechanically coupled to the compressor to provide mechanical power to drive the compressor.

13. A method of hybrid air conditioning as in claim 12 and further comprising, when the combustion engine is running and air conditioning is required, configuring the compressor as mechanically coupled to the combustion engine such that the combustion engine produces mechanical power for driving the compressor.

14. A method of hybrid air conditioning as in claim 12 and further comprising monitoring the rechargeable battery voltage and the speed of the electric machine and, when the electric machine is generating electric power for charging the rechargeable battery unit, controlling the charging current applied to the rechargeable battery unit to be directly proportional to the speed of the electric machine.
